(19) United States
(12) Patent Application Publication
(10) Pub. No.: US 2026/0023496 A1
(43) Pub. Date: Jan. 22, 2026

(54) CONFIGURABLE PARTITIONS AND MEMORY TYPE INDEPENDENCE IN A MEMORY SYSTEM

(71) Applicant: Micron Technology, Inc., Boise, ID (US)

(72) Inventors: Zheng Wang, Louisville, CO (US); Steffen Buch, Munich (DE)

(21) Appl. No.: 19/260,141

(22) Filed: Jul. 3, 2025

Related U.S. Application Data
(60) Provisional application No. 63/672,623, filed on Jul. 17, 2024.

(51) Int. Cl. G06F 3/06

(52) U.S. Cl. CPC G06F 3/0644; G06F 3/0619; G06F 3/0631; G06F 3/0685

(57) ABSTRACT

Methods, systems, and devices for configurable partitions and memory type independence in a memory system are described. A memory system may support different storage configurations for provisioning, including a first configuration for prioritizing high user capacity or terabytes written (TBW), and a second configuration for prioritizing independence or Freedom From Interference (FFI). In the first configuration, a memory system may support up to one partition of each supported memory type. A system memory area may share one or more pools with a first partition or memory type, while other pools may be specific to each other partition or memory type. In the second configuration, the memory system may support multiple partitions within some memory types each with one or more respective pools. By enabling different storage configurations for selection at a memory device, greater flexibility in provisioning may be provided while allowing prioritization of different characteristics.

### CROSS REFERENCE

The present Application for Patent claims priority to U.S. Patent Application No. 63/672,623 by Wang et al., entitled “CONFIGURABLE PARTITIONS AND MEMORY TYPE INDEPENDENCE IN A MEMORY SYSTEM,” filed Jul. 17, 2024, which is assigned to the assignee hereof, and which is expressly incorporated by reference in its entirety herein.

### TECHNICAL FIELD

The following relates to one or more systems for memory, including configurable partitions and memory type independence in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports configurable partitions and memory type independence in a memory system in accordance with examples as disclosed herein.

FIG. 2 shows an example of a provisioning diagram that supports configurable partitions and memory type independence in a memory system in accordance with examples as disclosed herein.

FIGS. 3A and 3B show examples of storage configuration charts that support configurable partitions and memory type independence in a memory system in accordance with examples as disclosed herein.

FIG. 4 shows a block diagram of a memory system that supports configurable partitions and memory type independence in a memory system in accordance with examples as disclosed herein.

FIG. 5 shows a flowchart illustrating a method or methods that support configurable partitions and memory type independence in a memory system in accordance with examples as disclosed herein.

### DETAILED DESCRIPTION

Some memory systems (e.g., universal flash storage (UFS) devices, among other examples) may accommodate various applications with different levels of data criticality, different read or write patterns, different usage patterns, or any combination thereof. Additionally, or alternatively, a memory system may include one or more different memory types for storage of data (e.g., normal memory, enhanced memory (EM) type 1, EM type 2, other memory types, or any combination thereof). Supporting, via a single memory system, different applications, different memory types, or both across one or more partitions within the memory system may reduce the lifetime or effectiveness of the memory system, in some cases. For example, a memory system may support the use of wear leveling pools to distribute wear evenly across a device. The wear leveling pools may include one or more free or otherwise less-frequently used blocks of memory for new write operations. The memory system may additionally, or alternatively, include one or more spare block pools for bad block management, as well as flash translation layer (FTL) algorithms (e.g., for wear leveling). In some cases, a spare block pool shared between two or more different applications or memory types, including a first memory type associated with a smaller quantity of writes, such as for storing critical data associated with less errors (and thus less write operations), and a second memory type associated with relatively large quantities of writes, may be exhausted early due to additional writes incurred by the second memory type, such as an application for storing non-critical data with a relatively large quantity of defects and thus associated with additional write operations. Such effects of one application or memory type on another may be referred to as interference, and may reduce the lifetime of a memory system. Some systems may separate or isolate different applications, partitions, pools, or devices (e.g., may separate critical and non-critical data) to mitigate interference, which may be referred to as independence, or Freedom From Interference (FFI). However, separating or isolating data partitions and/or pools may reduce a block budget as well as a total user capacity (e.g., user area available for memory storage of user applications) or terabytes written (TBW) (e.g., a total quantity of data that may be written over the lifetime of a memory system).

Techniques described herein support one or more flexible storage configurations (e.g., provisioning configurations) to balance a tradeoff between user capacity or TBW, and independence or FFI within a memory system. For example, a memory system may support different storage configurations for provisioning, including a first configuration for prioritizing relatively high user capacity or TBW, and a second configuration for prioritizing independence or FFI between partitions of memory. In the first configuration (e.g., a first type of configuration), a memory system may support up to one partition of each supported memory type, and a system memory area (e.g., including system operating data, metadata, or the like) may share one or more pools (e.g., wear leveling pools, spare block pools, memory management operation pools) with a first partition or memory type (e.g., EM1), while other pools may be specific to each other partition or memory type. In some cases, a system memory area may represent one or more virtual blocks used to store data, metadata, algorithms, other operating parameters, or any combination thereof for one or more system applications, or may include one or more spare blocks for system applications. In the second configuration (e.g., a second type of configuration) prioritizing independence, the memory system may support multiple partitions within some memory types (e.g., each memory type may support one or more partitions). Further, each partition may have one or more respective pools (e.g., no pools are shared between partitions). Pool-sharing with relatively limited partition combinations in the first configuration may increase a user area and TBW, while the second configuration may isolate data within a partition to increase independence and reduce interference between memory partitions so that an overall lifetime of a memory system may not be compromised by over-usage of different data or applications. Providing flexible provisioning may thereby provide for a flexible tradeoff between various memory system benefits, such that a user may achieve improved results for various use cases.

In addition to applicability in memory systems as described herein, techniques for configurable partitions and memory type independence in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing greater flexibility in selecting prioritized advantages. For example, flexibility in storage configurations may improve user experience by allowing a user to increase a user area during use, which may decrease processing and latency times while increasing capacity for one or more applications in the first configuration, while also enabling a user to select to increase the lifetime of a device by isolating data in the second configuration, among other benefits.

In addition to applicability in memory systems as described herein, techniques for configurable partitions and memory type independence in memory systems may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by enabling a user to implement a configuration to increase independence and FFI, which may increase the overall lifetime of a device, thereby reducing electronic waste and materials used for manufacturing additional devices, among other benefits.

Features of the disclosure are illustrated and described in the context of systems, devices, and circuits. Features of the disclosure are further illustrated and described in the context of provisioning diagrams, storage configuration charts, block diagrams, and flowcharts.

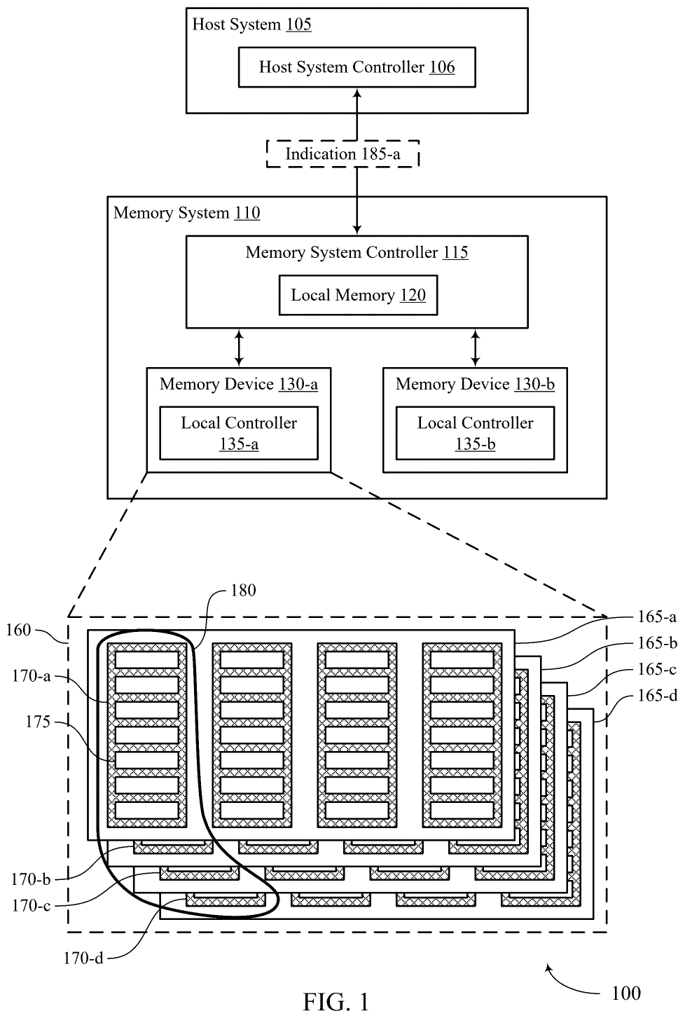

FIG. 1 shows an example of a system 100 that supports configurable partitions and memory type independence in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

As described herein, the system 100 may support one or more flexible storage configurations to balance a tradeoff between user capacity and independence between partitions. For example, the memory system 110 may support different configurations for provisioning, including a first configuration for prioritizing relatively high user capacity, and a second configuration for prioritizing independence and reduced interference between partitions of memory. In the first configuration prioritizing capacity, the memory system 110 may support up to one partition (e.g., of one or more virtual blocks 180) of each supported memory type, where a system memory area may share one or more pools with a first partition or memory type while other pools may be specific to each other partition. In the second configuration prioritizing independence, the memory system may support multiple partitions within some memory types and each partition may have one or more respective pools.

In some examples, the configuration may be indicated by the host system 105. For example, the host system 105 may transmit an indication 185-a of a selected configuration (e.g., one of the first configuration or the second configuration). The configuration may be selected via user input, based on one or more parameters, or both. Additionally, or alternatively, the memory system controller 115 may generate the indication 185-a. In response to receiving the indication 185-a, the memory system 110 (e.g., the memory system controller 115 or other component) may allocate multiple partitions of memory within the one or more memory devices 130 and one or more pools of memory cells based on the indicated configuration. In some examples, the allocation may occur during an initialization procedure, during manufacture, within a client setup environment, or the like. Additionally, or alternatively, the indication 185-a may be received dynamically during operation, and the memory system 110 may switch allocations dynamically.

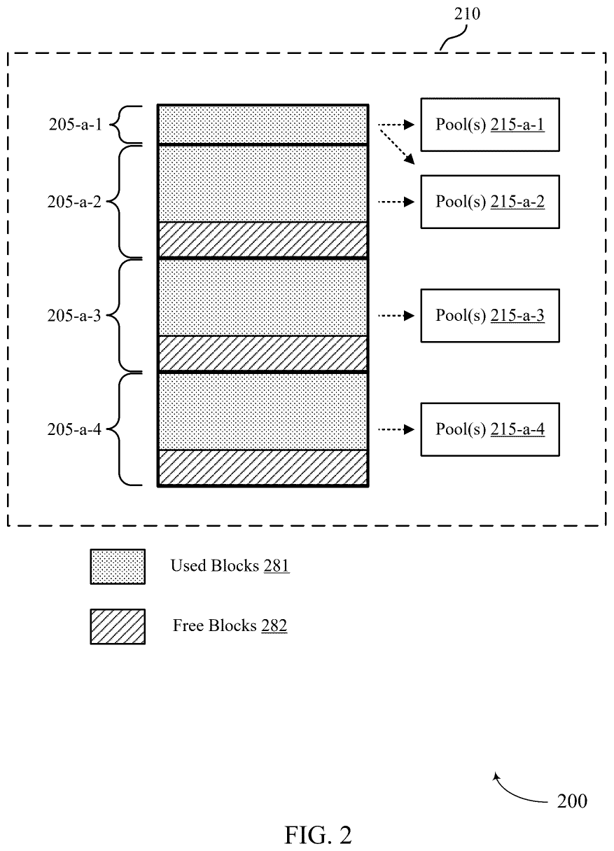

FIG. 2 shows an example of a provisioning diagram 200 that supports configurable partitions and memory type independence in a memory system in accordance with examples as disclosed herein. One or more aspects of the provisioning diagram 200 may implement or be implemented by one or more aspects of the system 100. For example, the provisioning diagram 200 may illustrate one or more partitions 205 of a memory system 210, which may represent a memory system 110 as described in FIG. 1. Each partition 205 may include one or more free blocks 281 (e.g., free virtual blocks 180), one or more used blocks 282 (e.g., used blocks 180 storing previously written data), or both. In some examples, the provisioning diagram 200 may support flexible storage configurations as described herein.

The memory system 210 may provision a set of virtual blocks 180 of one or more devices, or a set of blocks 170 of a single device, into partitions 205-a-1, 205-a-2, 205-a-3, and 205-a-4. Each partition 205 may use one or more shared or individual pools 215. For example, one or more partitions 205 may include overprovisioning of one or more spare blocks, so that there is a quantity of extra blocks of memory cells allocated for bad block management for one or more partitions (e.g., replacing early-terminated blocks due to wear), FTL algorithms involving an FTL protocol layer for mapping rules and wear-leveling, or other applications (e.g., to prevent a system from being unable to store new data without replacing old data). In such an example, a pool 215 may be an example of a spare block pool, and may correspond to a quantity of free blocks 282 (e.g., blocks not storing data) within a partition 205. A pool 215 may, additionally, or alternatively, represent a wear leveling pool that may point to or otherwise include a quantity of free blocks 282 across one or more partitions 205 for storage of new data for wear leveling operations, or to both a quantity of free blocks 282 and a quantity of used blocks 281 for rearranging data and storing new data for wear leveling operations (e.g., to distribute wear across blocks). In some examples, wear leveling pools, spare block pools, among other pools 215 may be referred to as memory management operation pools.

In some examples, the memory system 210 may accommodate multiple types of usages, including various applications with potentially different data criticality and read or write patterns. For example, some data for some applications stored in one or more of the partitions 205 may be relatively critical to the memory system 210 (e.g., may be used in different system operations, may have a relatively high priority), and thus may include more robust bit protection and be associated with fewer bugs and errors than relatively non-critical data of one or more different applications (e.g., data associated with user applications or non-system related applications, such as video game data). Critical data may include data that has relatively high importance in maintaining reliable operability of the memory system 210, including in systems in which safety is a priority, such as automotive systems, among other examples. Relatively critical data may thereby be programmed carefully and accurately to ensure reliability and safety of the system. In some cases, non-critical data may thus be associated with a greater quantity of write operations than critical data, as non-critical data may include more bugs, or be less concise, and may involve more frequent garbage collection, or may be rewritten more frequently as data changes. Further, different applications may impose different parameters in terms of endurance, data retention, and other characteristics, which may also result in different read or write patterns.

The memory system 210 (e.g., a UFS system, a UFS device) may also support different memory types, where a memory type may correspond to a different set of characteristics associated with how one or more memory cells are configured to store data. For example, the memory system 210 may support a “normal” memory type, which may in some cases include TLC, SLC, MLC, QLC, or other levels of memory, and may support a write-booster (WB) function that enables relatively fast write operations. A system memory area also may, in some cases, represent another memory type, or may be associated with one or more memory types. A system memory area may include one or more blocks of memory allocated for system operating data, metadata, control information, or the like. Other memory types may include an enhanced memory (EM) type 1 or an EM type 2 supporting additional features or characteristics, such as different trim values, for memory storage, among other memory types. In some examples, a memory system 210 may allow a co-existence of multiple memory types in a single memory system or memory device (e.g., in the same card) during provisioning (e.g., configuration of one or more logical units, or logical unit numbers (LUNs)) by a user. Some memory types may involve a relatively high frequency of read and write operations, or program and erase (PE) cycles (e.g., for high endurance), where more frequent reads and writes may also result in more frequent system table updates (e.g., of L2P tables), such as for relatively intensive small chunk or random write operations.

In some examples, supporting different applications or memory types may shorten the lifetime of the memory system 210, or of one or more devices of the memory system 210. For example, the memory system 210 may store both critical and non-critical data, which may share the same set of pools 215 (e.g., as they may be part of the same partition 205 or share pools across partitions 205), and may experience interference between the two data types. In such an example, a greater quantity of PE cycles caused by the non-critical data may contribute to early exhaustion of the pools 215 (e.g., of a spare block pool) shared for both data types, and may result in an early life termination of one or more devices, or of the memory system 210 itself (e.g., card), compared to a termination if the critical data was separate from other data. Similarly, using more than one memory type within the memory system 210 may result in interference between memory types because, for example, additional write operations and table updates of one memory type may cause early exhaustion of the memory system 210 or one or more devices (e.g., a card) including both memory types (e.g., because a pool shared between two memory types with the same or different partitions may be used up, or due to poor handling of a spare block pool policy, or the like). In some cases, the memory system 210 may separate or otherwise isolate critical and non-critical data in the same UFS device without interference between data partitions (e.g., independence, or FFI) to extend the lifetime of one or more devices. However, such independence may reduce a user capacity (e.g., user block budget) or TBW compared to pool-sharing.

As described herein, the memory system 210 (e.g., a UFS device, such as a NAND system, including NAND devices, an mNAND system, an SSD, or other types of storage systems and storage devices), may support flexible provisioning configurations, which may balance tradeoffs between user capacity and independence, by providing selection for one or more prioritized parameters. For example, the memory system 210 may support communicating and storing an indication (e.g., an indication 185 received from a host system 105) of a configuration selected from one or more candidate configurations (e.g., for different provisioning options) for storage that are supported by the memory system 210 (e.g., storage configurations). In some cases, a user may configure a selected configuration, a selected configuration may be set during manufacture, or a configuration may be automatically selected by a memory system 210 based on one or more parameters. In some cases, a configuration may be changed on the fly during operation of the memory system 210. Additionally, or alternatively, a device or memory system may be configured during its lifetime to change from one configuration to another, or may keep the same configuration for a full lifetime after selection during provisioning before operation. For example, the configuration may be selected prior to deployment of the memory system 210, or during an initialization or setup operation for the memory system 210. In some cases, a host system may monitor or receive an indication of different configurations supported at the memory system 210, and may select a configuration based on user input or one or more parameters, which may be based on an implementation of the memory system 210.

In some examples, a first configuration of the candidate configurations may prioritize a relatively high (or highest possible) user capacity (e.g., TBW). For example, the first configuration may support up to one partition (and no more) of each memory type, where each partition 205 may correspond to a different memory type. Further, a system memory area may share one or more same pools (e.g., a wear leveling pool and spare block pool) with a first memory type from among the one or more memory types. The first memory type may be, for example, EM1, if EM1 memory is configured. For example, the partition 205-a-1 may correspond to a system memory area, while the partitions 205-a-2 through 205-a-4 may store data for a user and for one or more applications. In such an example, the partition 205-a-2 may correspond to EM1 memory, and both the partitions 205-a-1 and 205-a-2 may share one or more pool(s) 215-a-2.

In some cases, a second configuration may prioritize a relatively high (or highest possible) degree of independence, or FFI, among data partitions, where each pool 215 (e.g., data, tables, data block pools, spare block pools, static SLC block pools) may be separated for different partitions. For example, each of the partitions 205-a-1, 205-a-2, 205-a-3, and 205-a-4 may be separated with one or more separate pools 215 (e.g., dedicated wear leveling pools and dedicated spare block pools), including pools 215-a-1, 215-a-2, 215-a-3, and 215-a-4, respectively, so that each partition 205 has its own set of one or more pools. For example, a system memory area represented by the partition 205-a-1 may include the one or more pools 215-a-1.

In some examples, the second configuration may support multiple partitions of some memory types to allow further degrees of data isolation. For example, the partition 205-a-2 may correspond to virtual blocks 180 across multiple types of memory. In some cases, the second configuration may stretch a block budget and result in user capacity (e.g., user area) reduction or TBW reduction, where such a reduction may be defined at the memory system 210. For example, the memory system 210 may tolerate a level of reduction above a threshold, where such a tradeoff may be leveraged by a customer if independence is selected (e.g., prioritized, valued) over user capacity or TBW reduction.

In some cases, after a spare block pool is exhausted (e.g., after a quantity of available, or usable, memory cells of the spare block pool satisfies a threshold quantity of memory cells) in one or more examples of the various configurations (e.g., either the first configuration or the second configuration) described herein, a partition 205 may become read-only (e.g., may be operated in a read-only mode).

Using a selected and/or indicated configuration, the memory system 210 may perform different access and memory management operations. For example, one or more controllers of the memory system 210, a host system 105, or both, may communicate (e.g., exchange between host system 105 and memory system 210, transmit to local memory devices) one or more access commands in accordance with an allocation made in accordance with an indicated configuration (e.g., each access command may indicate one or more logical addresses associated with one or more allocated partitions 205). The memory system 210 may thus perform one or more access operations based on allocating different partitions 205 and receiving the one or more access commands. The memory system 210 may also perform one or more memory management operations (e.g., including one or more wear leveling operations) for configured partitions 205 using one or more associated pools 215 and in accordance with the allocation.

In some cases, by having multiple data partitions, or endurance groups, (e.g., including multiple of the same memory type), each with separate (e.g., dedicated) pools, data may be relatively isolated within a separate partition 205. In case of relatively aggressive usage of a subset of partitions, other partitions may not be impacted, and thus the overall lifetime of a device or memory system may not be compromised by over-usage of the subset of partitions. In some cases, such independence may come at the cost of user area reduction or TBW reduction, where a user may select the first configuration for pool-sharing with more limited partition combinations if greater TBW is selected with a higher priority than independence, or memory system lifetime (e.g., device lifetime). For example, although TBW may correspond to greater data written over the lifetime of a device or system, TBW may not necessarily result in a longer lifetime, but increasing available storage for user data may increase TBW.

Additionally, or alternatively, one or more other configurations may be considered. For example, a third configuration may consider a balance of user capacity and independence by configuring some partitions to share pools 215 while configuring other partitions with separate pools 215. Additionally, or alternatively, configurations may involve separation of critical and non-critical data into separate partitions 205 with separate pools 215 (e.g., for independence), or partitions 205 with both critical and non-critical data, or sharing of pools 215 between critical data partitions and non-critical data partitions, among other examples. Further, any other configuration based on any prioritized parameters may be considered. For example, a fourth configuration may be based on parameters other than prioritizing independence or user capacity (e.g., for non-critical data applications).

The memory system 210 as described herein may thereby support flexible provisioning and configurations of memory partitions and corresponding pools 215. A single manufacturer may thereby manufacture multiple memory systems 210 with the same or similar manufacturing configuration, and the memory systems 210 may be deployed and used in a variety of different scenarios to fit different customer desires. For example, the same memory system 210 may be deployed in a first use case to prioritize a first set of parameters, such as increased TBW and may also be deployed in a second use case to prioritize a second set of parameters, such as reduced interference between application data, or the like.

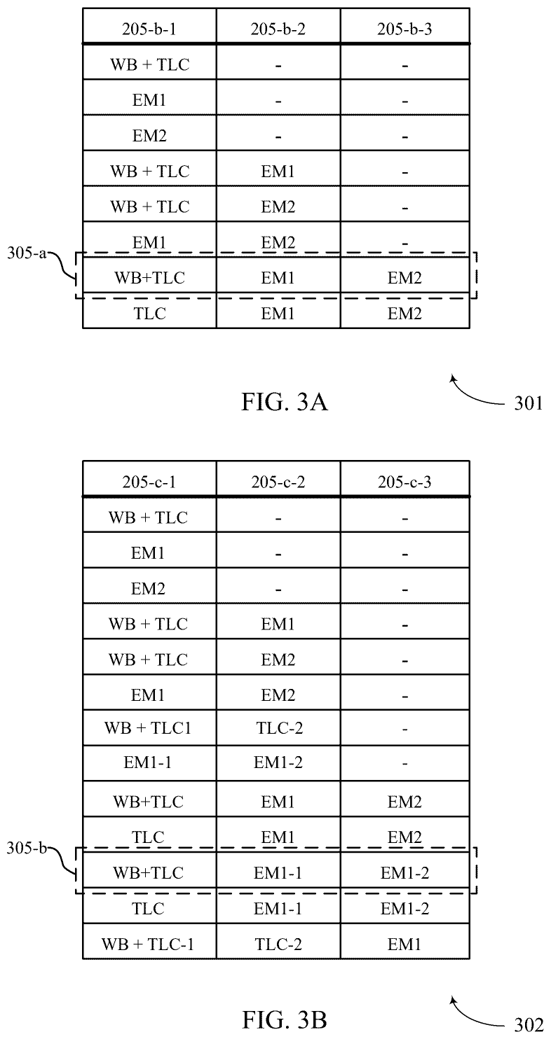

FIGS. 3A and 3B show examples of storage configuration charts 301 and 302, respectively, that support configurable partitions and memory type independence in a memory system in accordance with examples as disclosed herein. One or more aspects of the storage configuration charts 301 and 302 may be implemented by one or more aspects of the system 100 and the provisioning diagram 200 described with reference to FIGS. 1 and 2. For example, the storage configuration charts 301 and 302 may illustrate different storage configurations 305 according to different partitions 205 and pools 215 as discussed in FIG. 2.

In the example of FIG. 3A, the storage configuration chart 301 may illustrate different examples of the first configuration described with respect to FIG. 2 that prioritizes a user capacity or TBW. For example, the storage configuration chart 301 may illustrate partitions 205-b-1, 205-b-2, and 205-b-3 allocated by a memory system 110 or 210 in accordance with a storage configuration 305 being indicated (e.g., by a host system 105, selected by a user). In this example, the indicated storage configuration 305 may support a single partition per memory type. For example, an example storage configuration 305-a may include allocating the provision 205-b-1 with TLC memory supporting WB, the partition 205-b-2 with EM1 memory, and the partition 205-b-3 with EM2 memory. The memory system 110 or 210 may also allocate pools for each of the partitions 205-b and corresponding memory type, such as separate pools for TLC memory, for EM1 memory, and for EM2 memory. In some cases, one or more pools may be shared between an EM1 memory and a system memory area. Additionally, or alternatively, a single partition, such as the 205-b-1, may be configured with TLC memory, TLC memory supporting WB, EM1 memory, or EM2 memory, or two partitions 205 may be configured.

In the example of FIG. 3B, the storage configuration chart 302 may illustrate different examples of the second configuration described with respect to FIG. 2 that prioritizes a degree of independence or FFI. For example, the storage configuration chart 302 may illustrate partitions 205-c-1, 205-c-2, and 205-c-3 allocated by a memory system 110 or 210 based on another storage configuration 305 being indicated. In this example, the indicated storage configuration 305 may support multiple partitions within each memory type. For example, in an example storage configuration 305-b, a memory system 110 or 210 may allocate the partition 205-c-1 with TLC memory supporting WB, the partition 205-c-2 as a first EM1 partition EM1-1, and the partition 205-c-3 as a second EM1 partition EM1-2. Additionally, or alternatively, additional TLC-1 and TLC-2 partitions (supporting or without WB) may be allocated, as well as EM2-1 and EM2-2 partitions, among other examples of memory types. In some examples, separate pools 215 may be allocated for each of the partitions 205-c-1 through 205-c-3, including separate pools for different partitions of the same memory type and a separate pool 215 for a system memory area. In some cases, having separate pools 215 may involve separating a table block pool from a static SLC block pool.

In some examples, separate pools 215 may result in extra virtual blocks 180, which may be pulled from user capacity reduction, or a higher EM1 or EM2 scaling factor (e.g., as each separate pool may include its own overprovisioned blocks, and so may use up more memory for more pools). Further, provisioning in the storage configuration chart 302 may be based on a relatively relaxed defined TBW value or block budget. Additionally, or alternatively, although WB may be discussed and illustrated in FIGS. 2, 3A, and 3B, a dynamic SLC cache may be considered, which may be used to implement WB, or to replace WB with a different implementation. As illustrated in FIG. 3B, a second type of configuration associated with improved independence may support a larger quantity of potential memory allocations than the first type of configuration associated with improved TBW, as described with reference to FIG. 3A. For example, because the second type of configuration may support more than one partition 205 for a single memory type, there may be more potential or candidate memory partition allocations.

A memory system 110 or 210 as described herein may thereby be configured to support multiple different types of storage configurations each associated with varying storage allocations and corresponding benefits for memory operation performance. Once a configuration is selected by a user or other component, the memory system 110 or 210 may allocate one or more partitions and pools of memory blocks in accordance with the configuration protocols. FIGS. 3A and 3B illustrate configuration charts 301 and 302 that include examples of different memory types and corresponding allocations of partitions 205. However, it is to be understood that any quantity or variety of memory types and any combination or other allocation of memory may be supported by the memory system.

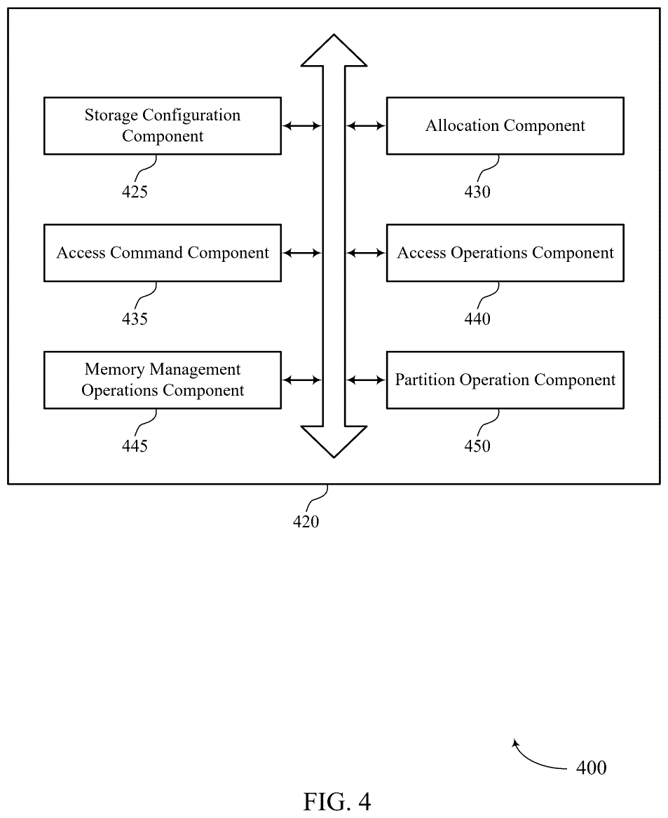

FIG. 4 shows a block diagram 400 of a memory system 420 that supports configurable partitions and memory type independence in a memory system in accordance with examples as disclosed herein. The memory system 420 may be an example of aspects of a memory system as described with reference to FIGS. 1 through 3B. The memory system 420, or various components thereof, may be an example of means for performing various aspects of configurable partitions and memory type independence in a memory system as described herein. For example, the memory system 420 may include a storage configuration component 425, an allocation component 430, an access command component 435, an access operations component 440, a memory management operations component 445, a partition operation component 450, or any combination thereof. Each of these components, or components of subcomponents thereof (e.g., one or more processors, one or more memories), may communicate, directly or indirectly, with one another (e.g., via one or more buses).

The storage configuration component 425 may be configured as or otherwise support a means for receiving an indication of a storage configuration for the memory system, the storage configuration one of a plurality of candidate storage configurations supported by the memory system, where the plurality of candidate storage configurations includes: a first storage configuration associated with allocation of a single partition for each memory type of a plurality of memory types of the memory system and associated with at least one shared pool of memory cells that is configured to be shared for memory management operations associated with at least two memory types of the plurality of memory types of the memory system; and a second storage configuration associated with allocation of one or more partitions for each memory type of the plurality of memory types and associated with at least one separate pool of memory cells for the memory management operations for each memory type of the plurality of memory types. The allocation component 430 may be configured as or otherwise support a means for allocating a plurality of partitions of memory within the memory system and a plurality of pools of memory cells within the memory system in accordance with the indicated storage configuration, where each partition of the plurality of partitions is associated with at least one pool of the plurality of pools of memory cells for the memory management operations within the partition.

In some examples, the access command component 435 may be configured as or otherwise support a means for receiving one or more access commands in accordance with the allocation, each access command of the one or more access commands indicating one or more logical addresses associated with one or more partitions of the plurality of partitions memory. In some examples, the access operations component 440 may be configured as or otherwise support a means for performing one or more access operations based on allocating the plurality of partitions and based on receiving the one or more access commands.

In some examples, the memory management operations component 445 may be configured as or otherwise support a means for performing one or more memory management operations for the plurality of partitions of memory using one or more associated pools of the plurality of pools of memory cells and in accordance with the allocation.

In some examples, the one or more memory management operations include one or more wear leveling operations.

In some examples, the partition operation component 450 may be configured as or otherwise support a means for operating a partition of the plurality of partitions of memory in a read-only mode based on a quantity of available memory cells of a pool of memory cells associated with the partition satisfying a threshold.

In some examples, the at least one pool includes one or more memory cells configured for one or more wear leveling operations, one or more spare memory cells, or any combination thereof.

In some examples, the first storage configuration is associated with allocation of a first partition of memory for a first memory type of the plurality of memory types and a second partition of memory for a system memory area for operations of the memory system, the system memory area associated with a second memory type of the plurality of memory types; and the first storage configuration is associated with allocation of the at least one shared pool of memory cells that is shared for memory management operations associated with the first partition of memory for the first memory type and the second partition of memory for the system memory area.

In some examples, the second storage configuration is associated with allocation of a first partition of memory for a first memory type of the plurality of memory types and a second partition of memory for a system memory area for operations of the memory system, the system memory area associated with a second memory type of the plurality of memory types; and the second storage configuration is associated with allocation of a first pool of memory cells for the memory management operations for the first partition of memory for the first memory type and a second pool of memory cells for the memory management operations for the second partition of memory for the system memory area, the second pool of memory cells separate from the first pool of memory cells.

In some examples, the second storage configuration is associated with allocation of a first partition of memory for a first memory type of the plurality of memory types and allocation of a second partition of memory for the first memory type; the first partition is configured for storing system critical data of the first memory type; and the second partition is configured for storing system non-critical data of the first memory type.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

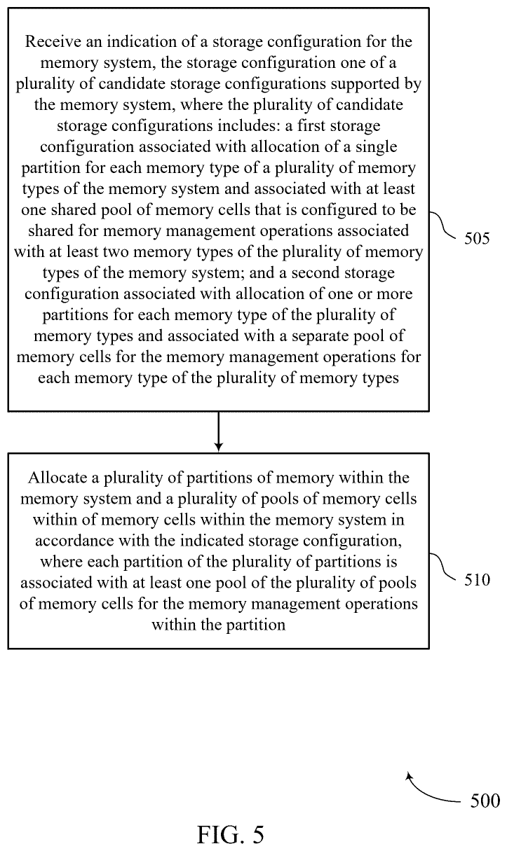

FIG. 5 shows a flowchart illustrating a method 500 that supports configurable partitions and memory type independence in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving an indication of a storage configuration for the memory system, the storage configuration one of a plurality of candidate storage configurations supported by the memory system, where the plurality of candidate storage configurations includes: a first storage configuration associated with allocation of a single partition for each memory type of a plurality of memory types of the memory system and associated with at least one shared pool of memory cells that is configured to be shared for memory management operations associated with at least two memory types of the plurality of memory types of the memory system; and a second storage configuration associated with allocation of one or more partitions for each memory type of the plurality of memory types and associated with at least one separate pool of memory cells for the memory management operations for each memory type of the plurality of memory types. The operations of 505 may be performed in accordance with examples as disclosed herein. For example, the memory system may include a storage configuration component 425 that may receive the indication (e.g., an indication 185) of the configuration (e.g., a configuration 305) from a host system.

At 510, the method may include allocating a plurality of partitions of memory within the memory system and a plurality of pools of memory cells within the memory system in accordance with the indicated storage configuration, where each partition of the plurality of partitions is associated with at least one pool of the plurality of pools of memory cells for the memory management operations within the partition. The operations of 510 may be performed in accordance with examples as disclosed herein. For example, the memory system may include an allocation component 430 that may allocate a plurality of partitions (e.g., partitions 205) and a plurality of pools (e.g., pools 215) in accordance with the indicated configuration.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication (e.g., an indication 185) of a storage configuration for the memory system, the storage configuration one of a plurality of candidate storage configurations supported by the memory system, where the plurality of candidate storage configurations includes: a first storage configuration associated with allocation of a single partition for each memory type of a plurality of memory types of the memory system and associated with at least one shared pool of memory cells that is configured to be shared for memory management operations associated with at least two memory types of the plurality of memory types of the memory system (e.g., a shared pool 215 between EM1 and a system memory area); and a second storage configuration associated with allocation of one or more partitions for each memory type of the plurality of memory types and associated with at least one separate pool of memory cells for the memory management operations for each memory type of the plurality of memory types (e.g., a separate pool 215 per partition 205, such as a separate pool 215 for an EM1-1 partition and a separate pool 215 for an EM2-2 partition, or a separate pool 215 per memory type); and allocating a plurality of partitions of memory within the memory system and a plurality of pools of memory cells within the memory system in accordance with the indicated storage configuration, where each partition of the plurality of partitions is associated with at least one pool of the plurality of pools of memory cells for the memory management operations within the partition.

Aspect 2: The method, apparatus, or non-transitory computer-readable medium of aspect 1, further including operations, features, circuitry, logic, means, or instructions, or any combination thereof for receiving one or more access commands in accordance with the allocation, each access command of the one or more access commands indicating one or more logical addresses associated with one or more partitions of the plurality of partitions memory and performing one or more access operations based on allocating the plurality of partitions and based on receiving the one or more access commands.

Aspect 3: The method, apparatus, or non-transitory computer-readable medium of any of aspects 1 through 2, further including operations, features, circuitry, logic, means, or instructions, or any combination thereof for performing one or more memory management operations for the plurality of partitions of memory using one or more associated pools of the plurality of pools of memory cells and in accordance with the allocation.

Aspect 4: The method, apparatus, or non-transitory computer-readable medium of aspect 3, where the one or more memory management operations include one or more wear leveling operations.

Aspect 5: The method, apparatus, or non-transitory computer-readable medium of any of aspects 1 through 4, further including operations, features, circuitry, logic, means, or instructions, or any combination thereof for operating a partition of the plurality of partitions of memory in a read-only mode based on a quantity of available memory cells (e.g., empty memory cells, or usable memory cells) of a pool of memory cells (e.g., a spare block pool) associated with the partition satisfying a threshold (e.g., a threshold quantity of memory cells).

Aspect 6: The method, apparatus, or non-transitory computer-readable medium of any of aspects 1 through 5, where the at least one pool includes one or more memory cells configured for one or more wear leveling operations (e.g., memory cells of a wear leveling pool), one or more spare memory cells (e.g., memory cells of a spare block pool), or any combination thereof.

Aspect 7: The method, apparatus, or non-transitory computer-readable medium of any of aspects 1 through 6, where the first storage configuration is associated with allocation of a first partition of memory for a first memory type of the plurality of memory types and a second partition of memory for a system memory area for operations of the memory system, the system memory area associated with a second memory type of the plurality of memory types; and the first storage configuration is associated with allocation of the at least one shared pool of memory cells that is shared for memory management operations associated with the first partition of memory for the first memory type and the second partition of memory for the system memory area.

Aspect 8: The method, apparatus, or non-transitory computer-readable medium of any of aspects 1 through 7, where the second storage configuration is associated with allocation of a first partition of memory for a first memory type of the plurality of memory types and a second partition of memory for a system memory area for operations of the memory system, the system memory area associated with a second memory type of the plurality of memory types; and the second storage configuration is associated with allocation of a first pool of memory cells for the memory management operations for the first partition of memory for the first memory type and a second pool of memory cells for the memory management operations for the second partition of memory for the system memory area, the second pool of memory cells separate from the first pool of memory cells.

Aspect 9: The method, apparatus, or non-transitory computer-readable medium of any of aspects 1 through 8, where the second storage configuration is associated with allocation of a first partition of memory for a first memory type of the plurality of memory types and allocation of a second partition of memory for the first memory type; the first partition is configured for storing system critical data of the first memory type; and the second partition is configured for storing system non-critical data of the first memory type.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 10: A system including: a host system; and a memory system (e.g., a memory system 110, a memory system 210) coupled with the host system (e.g., a host system 105), the memory system configured to support a plurality of candidate storage configurations, where each storage configuration of the plurality of candidate storage configurations is associated with a respective allocation of partitions (e.g., partitions 205) of memory for a plurality of memory types of the memory system, where each storage configuration of the plurality of candidate storage configurations is further associated with a respective allocation of pools (e.g., pools 215) of spare memory cells of the memory system for memory management operations associated with the plurality of memory types of the memory system, and where the memory system includes: a plurality of partitions of memory, each partition of the plurality of partitions of memory configurable to include one or more memory types of the plurality of memory types of the memory system in accordance with a storage configuration (e.g., the storage configuration 305-a, the storage configuration 305-b, another storage configuration 305), of the plurality of candidate storage configurations, for the memory system; and a plurality of pools of spare memory cells allocated for memory management operations, the plurality of pools of spare memory cells configurable for memory management operations associated with one or more memory types of the plurality of memory types of the memory system in accordance with the storage configuration for the memory system.

Aspect 11: The system of aspect 10, further including: one or more controllers of the host system, the memory system, or both (e.g., host system controller 106, memory system controller 115, local controllers 135), the one or more controllers configured to transmit, to the memory system, an indication of the storage configuration, from the plurality of candidate storage configurations, for the memory system.

Aspect 12: The system of aspect 11, where the one or more controllers are configured to transmit one or more access commands in accordance with the plurality of partitions of memory.

Aspect 13: The system of any of aspects 10 through 12, where the plurality of candidate storage configurations includes: a first storage configuration (e.g., the storage configuration 305-a or other storage configuration 305 illustrated in the storage configuration chart 301) associated with allocation of a single partition for each memory type of the plurality of memory types of the memory system and associated with at least one shared pool of memory cells that is configured to be shared for the memory management operations associated with at least two memory types of the plurality of memory types of the memory system.

Aspect 14: The system of any of aspects 10 through 13, where the plurality of candidate storage configurations includes: a second storage configuration (e.g., the storage configuration 305-b or other storage configuration 305 illustrated in the storage configuration chart 302) associated with allocation of one or more partitions for each memory type of the plurality of memory types and associated with at least one separate pool of memory cells for the memory management operations for each memory type of the plurality of memory types.

Aspect 15: The system of any of aspects 10 through 14, where one or more pools of the plurality of pools of spare memory cells are allocated for one or more wear leveling operations.

Aspect 16: The system of any of aspects 10 through 15, where the plurality of partitions of memory include at least a partition associated with a system memory area including one or more memory cells for system information.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system comprising:
a host system; and
a memory system coupled with the host system, the memory system configured to support a plurality of candidate storage configurations, wherein each storage configuration of the plurality of candidate storage configurations is associated with a respective allocation of partitions of memory for a plurality of memory types of the memory system, wherein each storage configuration of the plurality of candidate storage configurations is further associated with a respective allocation of pools of spare memory cells of the memory system for memory management operations associated with the plurality of memory types of the memory system, and wherein the memory system comprises:
a plurality of partitions of memory, each partition of the plurality of partitions of memory configurable to include one or more memory types of the plurality of memory types of the memory system in accordance with a storage configuration, of the plurality of candidate storage configurations, for the memory system; and
a plurality of pools of spare memory cells allocated for the memory management operations, the plurality of pools of spare memory cells configurable for the memory management operations associated with one or more memory types of the plurality of memory types of the memory system in accordance with the storage configuration for the memory system.

2. The system of claim 1, further comprising:
one or more controllers of the host system, the memory system, or both, the one or more controllers configured to transmit, to the memory system, an indication of the storage configuration, from the plurality of candidate storage configurations, for the memory system.

3. The system of claim 2, wherein the one or more controllers are configured to transmit one or more access commands in accordance with the plurality of partitions of memory.

4. The system of claim 1, wherein the plurality of candidate storage configurations comprises:
a first storage configuration associated with allocation of a single partition for each memory type of the plurality of memory types of the memory system and associated with at least one shared pool of memory cells that is configured to be shared for the memory management operations associated with at least two memory types of the plurality of memory types of the memory system.

5. The system of claim 1, wherein the plurality of candidate storage configurations comprises:
a second storage configuration associated with allocation of one or more partitions for each memory type of the plurality of memory types and associated with at least one separate pool of memory cells for the memory management operations for each memory type of the plurality of memory types.

6. The system of claim 1, wherein one or more pools of the plurality of pools of spare memory cells are allocated for one or more wear leveling operations.

7. The system of claim 1, wherein the plurality of partitions of memory comprise at least a partition associated with a system memory area comprising one or more memory cells for system information.

8. A method by a memory system, comprising:
receiving an indication of a storage configuration for the memory system, the storage configuration one of a plurality of candidate storage configurations supported by the memory system, wherein the plurality of candidate storage configurations comprises:
a first storage configuration associated with allocation of a single partition for each memory type of a plurality of memory types of the memory system and associated with at least one shared pool of memory cells that is configured to be shared for memory management operations associated with at least two memory types of the plurality of memory types of the memory system; and
a second storage configuration associated with allocation of one or more partitions for each memory type of the plurality of memory types and associated with at least one separate pool of memory cells for the memory management operations for each memory type of the plurality of memory types; and
allocating a plurality of partitions of memory within the memory system and a plurality of pools of memory cells within the memory system in accordance with the indicated storage configuration, wherein each partition of the plurality of partitions is associated with at least one pool of the plurality of pools of memory cells for the memory management operations within the partition.

9. The method of claim 8, further comprising:
receiving one or more access commands in accordance with the allocation, each access command of the one or more access commands indicating one or more logical addresses associated with one or more partitions of the plurality of partitions memory; and
performing one or more access operations based on allocating the plurality of partitions and based on receiving the one or more access commands.

10. The method of claim 8, further comprising:
performing one or more memory management operations for the plurality of partitions of memory using one or more associated pools of the plurality of pools of memory cells and in accordance with the allocation.

11. The method of claim 10, wherein the one or more memory management operations comprise one or more wear leveling operations.

12. The method of claim 8, further comprising:
operating a partition of the plurality of partitions of memory in a read-only mode based on a quantity of available memory cells of a pool of memory cells associated with the partition satisfying a threshold.

13. The method of claim 8, wherein the at least one pool comprises one or more memory cells configured for one or more wear leveling operations, one or more spare memory cells, or any combination thereof.

14. The method of claim 8, wherein:
the first storage configuration is associated with allocation of a first partition of memory for a first memory type of the plurality of memory types and a second partition of memory for a system memory area for operations of the memory system, the system memory area associated with a second memory type of the plurality of memory types; and
the first storage configuration is associated with allocation of the at least one shared pool of memory cells that is shared for the memory management operations associated with the first partition of memory for the first memory type and the second partition of memory for the system memory area.

15. The method of claim 8, wherein:
the second storage configuration is associated with allocation of a first partition of memory for a first memory type of the plurality of memory types and a second partition of memory for a system memory area for operations of the memory system, the system memory area associated with a second memory type of the plurality of memory types; and
the second storage configuration is associated with allocation of a first pool of memory cells for the memory management operations for the first partition of memory for the first memory type and a second pool of memory cells for the memory management operations for the second partition of memory for the system memory area, the second pool of memory cells separate from the first pool of memory cells.

16. The method of claim 8, wherein:
the second storage configuration is associated with allocation of a first partition of memory for a first memory type of the plurality of memory types and allocation of a second partition of memory for the first memory type;
the first partition is configured for storing system critical data of the first memory type; and
the second partition is configured for storing system non-critical data of the first memory type.

17. A memory system, comprising:
one or more memory devices; and
processing circuitry coupled with the one or more memory devices and configured to cause the memory system to:
receive an indication of a storage configuration for the memory system, the storage configuration one of a plurality of candidate storage configurations supported by the memory system, wherein the plurality of candidate storage configurations comprises:
a first storage configuration associated with allocation of a single partition for each memory type of a plurality of memory types of the memory system and associated with at least one shared pool of memory cells that is configured to be shared for memory management operations associated with at least two memory types of the plurality of memory types of the memory system; and
a second storage configuration associated with allocation of one or more partitions for each memory type of the plurality of memory types and associated with at least one separate pool of memory cells for the memory management operations for each memory type of the plurality of memory types; and
allocate a plurality of partitions of memory within the memory system and a plurality of pools of memory cells within the memory system in accordance with the indicated storage configuration, wherein each partition of the plurality of partitions is associated with at least one pool of the plurality of pools of memory cells for the memory management operations within the partition.

18. The memory system of claim 17, wherein the processing circuitry is further configured to cause the memory system to:
receive one or more access commands in accordance with the allocation, each access command of the one or more access commands indicating one or more logical addresses associated with one or more partitions of the plurality of partitions memory; and
perform one or more access operations based on allocating the plurality of partitions and based on receiving the one or more access commands.

19. The memory system of claim 17, wherein the processing circuitry is further configured to cause the memory system to:
perform one or more memory management operations for the plurality of partitions of memory using one or more associated pools of the plurality of pools of memory cells and in accordance with the allocation.

20. The memory system of claim 19, wherein:
the one or more memory management operations comprise one or more wear leveling operations.

21. The memory system of claim 17, wherein the processing circuitry is further configured to cause the memory system to:
operate a partition of the plurality of partitions of memory in a read-only mode based on a quantity of available memory cells of a pool of memory cells associated with the partition satisfying a threshold.

22. The memory system of claim 17, wherein the at least one pool comprises one or more memory cells configured for one or more wear leveling operations, one or more spare memory cells, or any combination thereof.
